(19) United States
(12) Patent Application Publication
(10) Pub. No.: US 2006/0125386 A1
(43) Pub. Date: Jun. 15, 2006

(54) Organic light emitting display with color filter

(76) Inventors: Pin Chang, Towfen Township (TW); Shi-Ping Lin, Daliao Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/039,890

(22) Filed: Jan. 24, 2005

(30) Foreign Application Priority Data
Dec. 14, 2004 (TW) 093220120

(51) Int. Cl. H05B 33/00; H01J 1/62

(52) U.S. Cl. 313/506; 313/504

(57) ABSTRACT

An organic light emitting display (OLED) with a color filter consists of a transparent substrate, a first electrode, an organic light emitting layer, and a second electrode. A color filter is printed on top or bottom side of the transparent substrate by a printing method. Furthermore, the color filter can also be made by a substrate such as plastic substrate or glass substrate being printed by a printing method.

### BACKGROUND OF THE INVENTION

The present invention relates to an organic light emitting display (OLED) with a color filter, especially to the disposition of the color filter of the organic light emitting display (OLED).

Due to high efficiency, low driving voltage, great potential of application to large-size and full-color monitors, the OLED (Organic Light Emitting Display) has drawn much attention of enterprises and research institute in various countries. The research of electroluminescence especially focuses on development and features of components made by organic materials and metal complexes. In development of new material, the wavelength of the molecule must be within the range of visible light and the molecule must be with enough radioactivity. Most of the research projects emphasis on search of new electroluminescent material, components manufacturing, wavelength, emitting efficiency and lifetime of the components.

Inside the OLED, the anode is a transparent conductive membrane made by indium-tin-oxide (ITO) sputtered or evaporated coated on a transparent glass or plastic substrate while the cathode is a metal electrode made of Mg, Li, or Al. The light emitting area between two electrodes consists of a hole transport layer, an emitting layer, and an electron transport layer. The light-emitting is based on electrodes with electrons and holes injected from a cathode and an anode that are used to selectively excite levels in an organic molecule. And the light output characteristics are highly dependent on the nature of the electron transporting materials (ETL) and the hole transport layer.

Full-color is a key point for the competitiveness of displays on the market. There are three kinds of LCD panels—RGB pixels that are independently addressable to emit a specific color, color conversion and color filter. As to the RGB pixels that cover various colors in range of visible light, its lifetime is only one tenth of the molecule-based device. Thus the lifetime and light-emitting efficiency of the polymer-based device are all need to be enhanced. The defect of the color conversion is that the material is easy to absorb blue light from environment so that the contrast of the graphics is reduced. At the same time, photoconductivity effect may also cause the problem of the quality of images. Regarding the color filter, it combines white organic light emitting diodes with color filters. The light emitted from the while OLED components passes through the color filter and three primary colors—red, green and blue are provided. By combination of these three primaries in different proportion, various colors are produced. The key point of this technology is in obtaining the white light with high efficiency and high purity. There is no need to run mask alignment process during the manufacturing process of the color filter. Thus color filters have the greatest potential to be applied to the future large-size, full-color OLED displays.

Refer to Taiwanese patent application publication No. 576124—“Full-color OLED” and FIG. 1, the device is composed by a transparent substrate 10′, a color filter 20′, a first electrode 30′, an organic light emitting layer 40′, and a second electrode 50′. The color filter 20′ is disposed between the substrate 10′ and the first electrode 30′. For preventing color mixing of red, green and blue color materials in color filters, a colorless, light-impermeable light shielding film is disposed between the color materials for light leak prevention and color mixing prevention. In addition, a drop between the color materials and light shielding film must be planarized. The conventional four times repeated manufacturing procedures of color filters having exposing, developing and photoresist stripping with photomask, as well as planarization requirement raise the manufacturing cost.

In order to improved above disadvantages, the present invention provides an organic light emitting display (OLED) with a color filter. The color filter is printed by a printing method such as ink jet printing, pad printing, planographic printing, relief printing, or screen process printing so as to reduce the manufacturing cost.

### SUMMARY OF THE INVENTION

It is therefore a primary object of the present invention to provide an OLED with a color filter that consists of a transparent substrate, a first electrode, an organic light emitting layer, and a second electrode. As to the color filter, it is printed on top or bottom side of the transparent substrate by a printing method.

It is a further object of the present invention to provide an OLED with a color filter with a substrate being printed on top or bottom side thereof by a printing method to form a color filter. The substrate is disposed over or under the transparent substrate.

In order to achieve above objects, the present invention provide an OLED with a color filter composed by a transparent substrate, a first electrode, an organic light emitting layer, and a second electrode. A color filter made by a substrate (plastic substrate or glass substrate) being printed by a printing method is disposed on top or bottom side of the transparent substrate. Furthermore, the color filter can also be printed directly on top or bottom side of the transparent substrate.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing of an organic light emitting display of a prior art;

FIG. 2 is a is a schematic drawing of a color filter in an organic light emitting display of an embodiment in accordance with the present invention;

FIG. 3 is a is a schematic drawing of a color filter in an organic light emitting display of a further embodiment in accordance with the present invention;

FIG. 4A is a schematic drawing of a color filter of an embodiment in accordance with the present invention;

FIG. 4B is a schematic drawing of a color filter of another embodiment in accordance with the present invention;

FIG. 5 is a schematic drawing of a color filter of a further embodiment in accordance with the present invention.

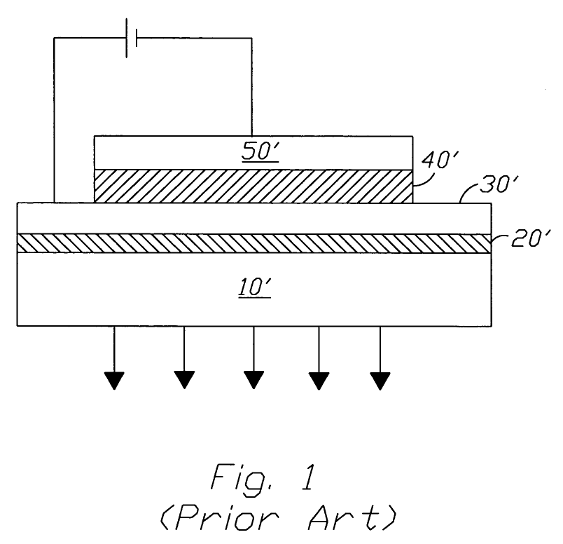

### DETAILED DESCRIPTION OF THE PREFFERED EMBODIMENT

Conventional manufacturing process of color filters is by photolithography that goes through mask alignment, exposure, development, and stripping process four times. The material and equipment for the process cause high manufacturing cost. The photolithography mainly includes three main steps: first is the photoresist coating of three primary colors-red, green, and blue; the second is proximity alignment exposure; and the last is development. A spin coating available now or inkjet printing developed by Dai Nippon PrintingCo. are all methods of coating photoresist for three primary colors—red(R), green(G), and blue(B). The present invention provides a color filter that is made by a single printing process, being printed on a plastic or a glass substrate. The cost is down to one fifth or one sixth.

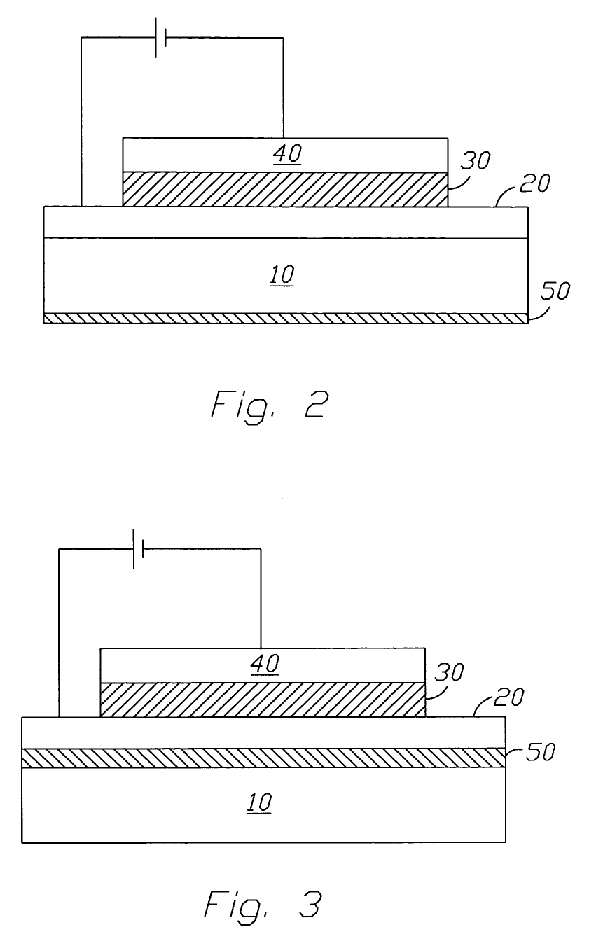

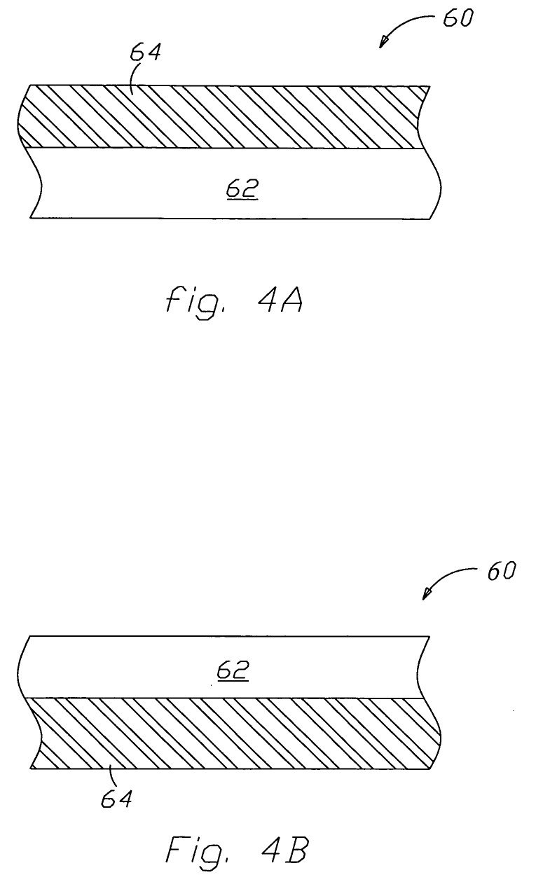

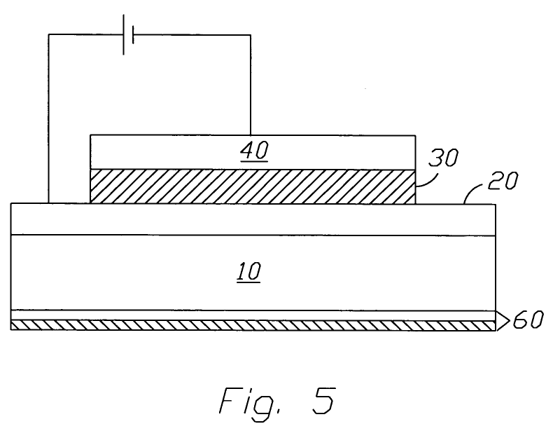

Refer to FIG. 2, an organic light emitting display (OLED) with color filter in accordance with the present invention consists of a transparent substrate 10, a first electrode 20, an organic light emitting layer 30 and a second electrode 40. The first electrode 20 is disposed over the transparent substrate 10 while the organic light emitting layer 30 is arranged over the first electrode 20. And the second electrode 40 is set over the organic light emitting layer 30. Furthermore, a color filter 50 is disposed under the transparent substrate 10. In this embodiment, the color filter 50 is printed on bottom surface or top surface of the transparent substrate 10 by ink jet printing, pad printing, planographic printing, relief printing, or screen process printing. Refer to FIG. 3, the color filter 50 is arranged between the transparent substrate 10 and the first electrode 20. The first electrode 20 is an ITO electrode while the second electrode 40 is a metal electrode. And the transparent substrate 10 is a plastic or glass electrode.

Moreover, a color filter 60 is made by a substrate. A colored pattern of R, G and B 64 of the color filter 60 is printed on a top surface of the substrate 62, as shown in FIG. 4A, or on a bottom surface of the substrate 62, as shown in FIG. 4B. The substrate 62 can be a plastic substrate or a glass substrate. The method of printing can be ink jet printing, pad printing, planographic printing, relief printing, screen process printing, and so on. Refer to FIG. 5, the location of the colored pattern 64 is close to the transparent substrate 10 or on the other side.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An organic light emitting display (OLED) with a color filter comprising:
a transparent substrate;
a first electrode disposed over said transparent substrate;
an organic light emitting layer arranged over said first electrode; and
a second electrode disposed over said organic light emitting layer;
wherein a color filter is printed on top or bottom surface of said transparent substrate.

2. The device according to claim 1, wherein said transparent substrate is a glass substrate.

3. The device according to claim 1, wherein said transparent substrate is a plastic substrate.

4. The device according to claim 1, wherein said first electrode is made of indium tin oxide (ITO).

5. The device according to claim 1, wherein said second electrode is a metal electrode.

6. The device according to claim 1, wherein said color filter is printed on top or bottom of said transparent substrate by ink jet printing.

7. The device according to claim 1, wherein said color filter is printed on top or bottom of said transparent substrate by pad printing.

8. The device according to claim 1, wherein said color filter is printed on top or bottom of said transparent substrate by planographic printing.

9. The device according to claim 1, wherein said color filter is printed on top or bottom of said transparent substrate by relief printing.

10. The device according to claim 1, wherein said color filter is printed on top or bottom of said transparent substrate by screen process printing.

11. An organic light emitting display (OLED) with a color filter comprising:
a transparent substrate;
a first electrode disposed over said transparent substrate;
an organic light emitting layer arranged over said first electrode; and
a second electrode disposed over said organic light emitting layer;
wherein a color filter is disposed over or under said transparent substrate and said color filter is made by a substrate being printed.

12. The device according to claim 11, wherein said transparent substrate is a glass substrate.

13. The device according to claim 11, wherein said transparent substrate is a plastic substrate.

14. The device according to claim 11, wherein said first electrode is made of indium tin oxide (ITO).

15. The device according to claim 1, wherein said second electrode is a metal electrode.

16. The device according to claim 11, wherein said substrate is a glass substrate.

17. The device according to claim 11, wherein said substrate is a plastic substrate.

18. The device according to claim 11, wherein said color filter is printed on top or bottom of said substrate by ink jet printing.

19. The device according to claim 11, wherein said color filter is printed on top or bottom of said substrate by pad printing.

20. The device according to claim 11, wherein said color filter is printed on top or bottom of said substrate by planographic printing.

21. The device according to claim 11, wherein said color filter is printed on top or bottom of said substrate by relief printing.

22. The device according to claim 11, wherein said color filter is printed on top or bottom of said substrate by screen process printing.
